(19) United States
(12) Patent Application Publication
(10) Pub. No.: US 2016/0189287 A1
(43) Pub. Date: Jun. 30, 2016

(54) Method for Ordering, Receiving, and Paying for Drink and Food Services Using a Smart Phone to Scan a Mobile Vehicle Tag Providing Identification and Location Information

(71) Applicant: Stan Van Meter, Eustis, FL (US)

(72) Inventor: Stan Van Meter, Eustis, FL (US)

(21) Appl. No.: 14/587,208

(22) Filed: Dec. 31, 2014

(51) Int. Cl. G06Q 30/06; G06Q 50/12; H04W 4/02

(52) U.S. Cl. CPC G06Q 30/0643; H04W 4/02; G06Q 30/0633; G06Q 50/12

(57) ABSTRACT

A method for ordering, receiving, and paying for drink and food services using a smart phone to scan a mobile vehicle tag, such as one found on a golf cart used on a golf course that can provide identification and location information. Using the smart phone, an order is placed for products or services. The order is sent from the smart phone, using the smart phone services which is then received by a mobile service or product provider. A tracking process and method then calculates where the services or product need to be delivered when prepared or ready. This is necessary as the party placing the order may also be moving along a route or from location to location so simply using the location when the order was placed would not allow deliver of the order to be completed.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to processing and tracking orders More specifically, the present invention relates to the remote purchasing of food and drink orders by one or more people who are moving with respect to a moving distributor of food and drink items that can track and deliver the order to a user's location at any given moment.

### BACKGROUND OF THE INVENTION

The present invention is a method for ordering, receiving, and paying for drink and food services using a smart phone to scan a mobile vehicle tag, such as one found on a golf cart used on a golf course that can provide identification and location information. Using the smart phone an order is placed for products or services. The order is sent from the smart phone, using the smart phone services which is then received by a mobile service or product provider. A tracking process and method then calculates where the services or product need to be delivered when prepared or ready.

### DEFINITIONS

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio(e.g. LTE), Wi-Fi, 3rd-party apps, motion sensor and mobile payment.

“Swipe” is a command used primarily with touchscreen devices, such as smartphones and tablets. It is also supported by some laptops with trackpads and desktop computers with trackpad input. A “swipe” involves quickly moving (or “swiping”) your finger across a touchscreen or trackpad. For example, swiping the screen from right to left in a photo viewing application typically displays the next photo. While browsing multiple photos, swiping up or down may allow you scroll through the photo library. Most smartphones also allow you to swipe left or right to switch between home screens. Devices that support multi-touch may allow you to swipe with multiple fingers to perform different functions. In the present invention, the Applicant/Inventor uses the phrase “gesture swipe” interchangeable with “swipe”.

A “User” is any person registered to use the computer system executing the method of the present invention.

A “web application” or “web app” is any application software that runs in a web browser and is created in a browser-supported programming language (such as the combination of JavaScript, HTML and CSS) and relies on a web browser to render the application.

### SUMMARY OF THE INVENTION

The present invention is a method for ordering, receiving, and paying for drink and food services using a smart phone to scan a mobile vehicle tag, such as one found on a golf cart used on a golf course that can provide identification and location information. Using the smart phone an order is placed for products or services. The order is sent from the smart phone, using the smart phone services which is then received by a mobile service or product provider. A tracking process and method then calculates where the services or product need to be delivered when prepared or ready. This is necessary as the party placing the order may also be moving along a route or from location to location so simply using the location when the order was placed would not allow deliver of the order to be completed as the time for the delivery party to reach the order location would be enough for the ordering party to have moved to a new location.

### BRIEF DESCRIPTION OF THE DRAWINGS

The accompanying drawings, which are incorporated herein form a part of the specification, illustrate the present invention and, together with the description, further serve to explain the principles of the invention and to enable a person skilled in the pertinent art to make and use the invention.

FIG. 1 is a flow chart illustrating the method of one embodiment of the present invention;

FIG. 2 is a flow chart illustrating the “service at the turn” method of one embodiment of the present invention;

FIG. 3 is a flow chart illustrating another embodiment of the present invention for providing beverage cart notices on high demand days in an alternative embodiment of the present invention; and

FIG. 4 is a flow chart illustrating the method of one embodiment of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

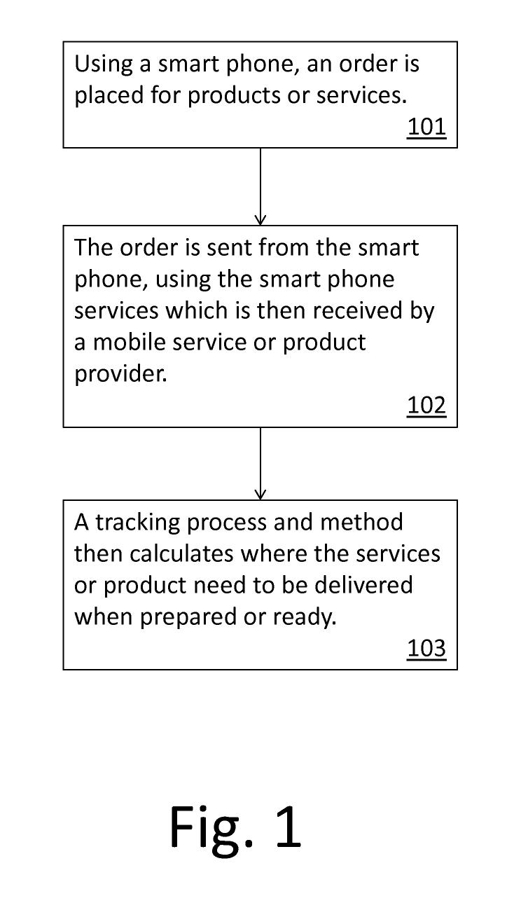

The present invention is a method for ordering, receiving, and paying for drink and food services using a smart phone to scan a mobile vehicle tag, such as one found on a golf cart used on a golf course that can provide identification and location information as shown in FIG. 1. Using the smart phone an order is placed for products or services 101. The order is sent from the smart phone, using the smart phone services which is then received by a mobile service or product provider 102. A tracking process and method then calculates where the services or product need to be delivered when prepared or ready 103. This is necessary as the party placing the order may also be moving along a route or from location to location so simply using the location when the order was placed would not allow deliver of the order to be completed as the time for the delivery party to reach the order location would be enough for the ordering party to have moved to a new location.

In one embodiment, the present invention is used on a golf course. In this embodiment, the method for determining delivery location is based on typical player speed/pace, order time, transit time between the delivering party's current location and other deliveries, and preparation time.

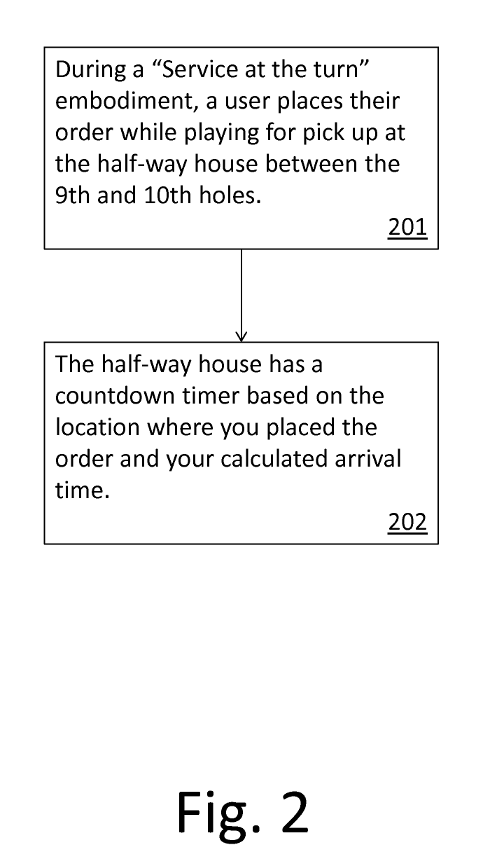

During a “Service at the turn” embodiment shown in FIG. 2, a user places their order while playing for pick up at the half-way house between the 9th and 10th holes 201. The half-way house has a countdown timer based on the location where you placed the order and your calculated arrival time 202.

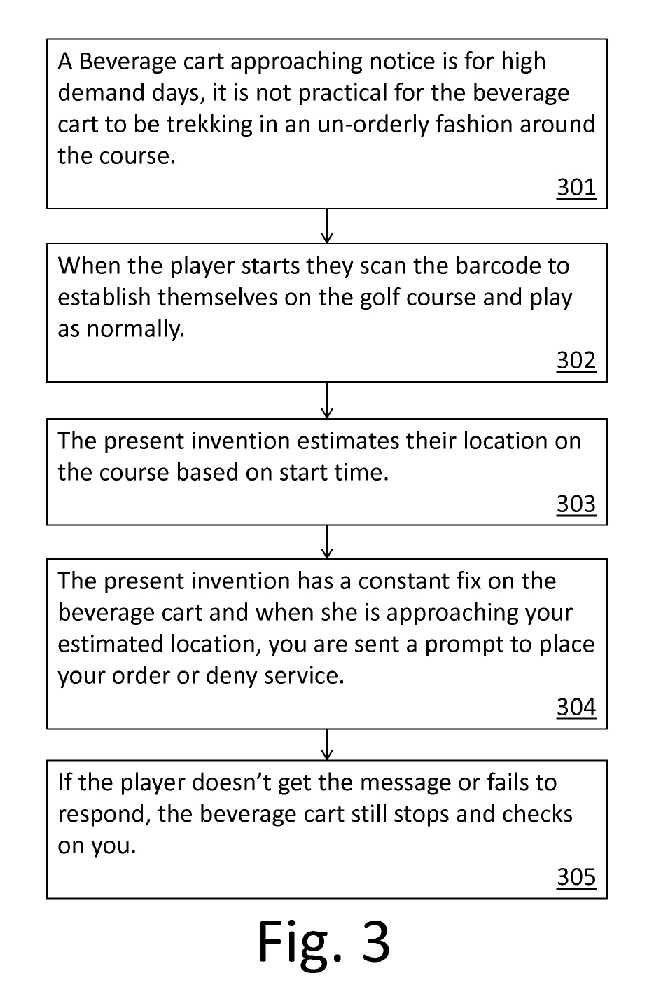

In another embodiment shown in FIG. 3, a Beverage cart approaching notice is for high demand days, it is not practical for the beverage cart to be trekking in an un-orderly fashion around the course 301. When the player starts they scan the barcode to establish themselves on the golf course and play as normally 302. The present invention estimates their location on the course based on start time 303. The present invention has a constant fix on the beverage cart and when she is approaching your estimated location, you are sent a prompt to place your order or deny service 304. If the player doesn't get the message or fails to respond, the beverage cart still stops and checks on them 305.

The present invention allows golfers, sports fans, and resort patrons to use their Smartphone to access a portable menu and place an order for immediate service and delivery without interrupting the activity at hand. To make this happen, the present invention uses individually encoded two dimensional barcodes (aka QR Codes) to determine the venue and location of the order. Bar codes are fixed to golf carts, stadium seats, and resort cabana chairs and umbrellas so an order is delivered precisely to its intended location. Customers access the menu through a specially designed web-app, or download a free application from ITUNES or the ANDROID Marketplace.

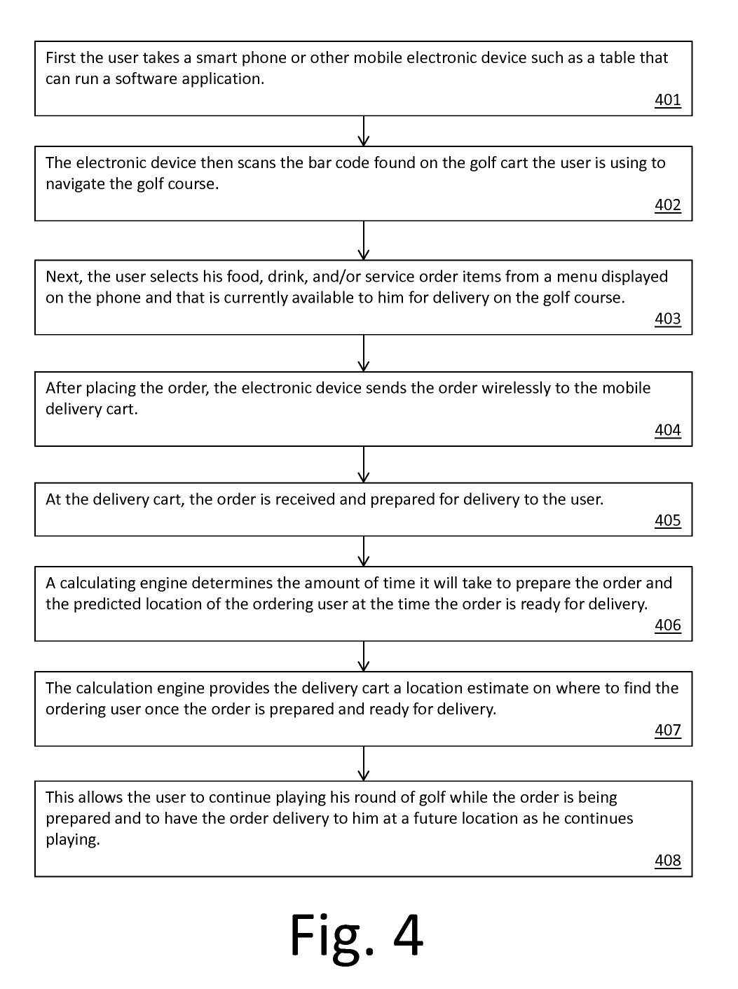

FIG. 4 illustrates the steps of the method for the present invention in on embodiment as applied to a golf course. First the user takes a smart phone or other mobile electronic device such as a table that can run a software application 401. The electronic device then scans the bar code found on the golf cart the user is using to navigate the golf course 402. Next, the user selects his food, drink, and/or service order items from a menu displayed on the phone and that is currently available to him for delivery on the golf course 403. After placing the order, the electronic device sends the order wirelessly to the mobile delivery cart 404. At the delivery cart, the order is received and prepared for delivery to the user 405. A calculating engine determines the amount of time it will take to prepare the order and the predicted location of the ordering user at the time the order is ready for delivery 406. This allows the user to continue playing his round of golf while the order is being prepared and to have the order delivery to him at a future location as he continues playing 408. The calculation engine provides the delivery cart a location estimate on where to find the ordering user once the order is prepared and ready for delivery 407.

The present invention may be used in other embodiments, in other venues where both customers and delivery carts or people are in constant motion. This can be any outdoor event, or even indoor events such as casinos, where users/patrons are constantly moving from one interior location to another, but are placing drink orders and need them delivered to a location.

The system is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for ordering, receiving, and paying for drink and food services using a smart phone recorded on non-transitory computer-readable medium and capable of execution by a computer, said method comprising the steps of:
providing an ordering module running software capable of execution by a mobile electronic device;
scanning a bar code on a mobile vehicle tag to identify the mobile vehicle in the software system;
the ordering module providing identification and location information of the mobile vehicle using the mobile electronic device e location services;
displaying a menu on the smartphone;
placing an order for products or services via the mobile electronic device;
sending the order from the smartphone, using the mobile electronic device services which is then received by a mobile service or product provider computer system; and
a tracking process and method then calculates where the services or product need to be delivered when prepared or ready with respect to the anticipate location of the party placing the order.

2. The method of claim 1, wherein the mobile electronic device is a smartphone.

3. The method of claim 1, wherein the mobile electronic device is a tablet computer

4. The method of claim 1, wherein the step of determining delivery location is based on typical player speed/pace, order time, transit time between the delivering party's current location and other deliveries, and preparation time.

5. The method of claim 1, further comprising the steps on a golf course;
placing an order while playing golf for pick up at a half-way house between the 9th and 10th holes; and
the half-way house if further comprised of a countdown timer based on the location where the order was placed and the calculated arrival time of the ordering party at the half-way house.

6. The method of claim 1, further comprising the steps on a golf course;
a Beverage cart approaching notice is for high demand days;
it is not practical for the beverage cart to be trekking in an un-orderly fashion around the course;
as a player starts their scan of the barcode to establish themselves on the golf course and play as normally, the present invention estimates their location on the course based on start time;
a constant fix on the beverage cart is maintained in the system; and
when the beverage cart is approaching an estimated location, they user is sent a prompt to place their order or deny service.

7. The method of claim 6 , further comprising the steps on a golf course;
if the message is not received and no denial of service is sent and received, the beverage cart will physically stop and checks for any orders.

8. The method of claim 1, wherein
patrons to use a smartphone to access a portable menu and place an order for immediate service and delivery without interrupting the activity at hand; and
individually encoded two dimensional barcodes (QR Codes) determine the venue and location of the order.

9. The method of claim 8, wherein bar codes are fixed to golf carts, stadium seats, and resort cabana chairs and umbrellas so an order is delivered precisely to its intended location.

10. The method of claim 1, wherein customers access the menu through a specially designed web-app, or download a free application.

11. A method for ordering, receiving, and paying for drink and food services using a smart phone recorded on non-transitory computer-readable medium and capable of execution by a computer, said method comprising the steps of:
providing an ordering module running software capable of execution by a mobile electronic device;
providing a smart phone or other mobile electronic device such as a table that can run a software application;
the electronic device then scans the bar code found on the golf cart the user is using to navigate the golf course;
the user selects his food, drink, and/or service order items from a menu displayed on the phone and that is currently available to him for delivery on the golf course;
after placing the order, the electronic device sends the order wirelessly to the mobile delivery cart;
at the delivery cart, the order is received and prepared for delivery to the user;
a calculating engine determines the amount of time it will take to prepare the order and the predicted location of the ordering user at the time the order is ready for delivery; and
the calculation engine provides the delivery cart a location estimate on where to find the ordering user once the order is prepared and ready for delivery.

12. The method of claim 1, wherein
the user to continues playing his round of golf while the order is being prepared; and
the order is delivered to him at a future location as he continues playing.
